(19) United States
(12) Patent Application Publication
(10) Pub. No.: US 2007/0119561 A1
(43) Pub. Date: May 31, 2007

(54) METHOD AND APPARATUS OF THE PREPARTION OF A FIBROUS STOCK SUSPENSION

(76) Inventors: Klaus Doelle, Kisslegg (DE); Volker Niggl, Weingarten (DE); Bernd Gueldenberg, Heidenheim (DE); Holger Humberg, Nattheim (DE)

Correspondence Address: Todd T. Taylor;Taylor & Aust, P.C., 142 S. Main Street, P.O. Box 560, Avilla, IN, 46710, US

(21) Appl. No.: 11/608,029

(22) Filed: Dec. 7, 2006

Related U.S. Application Data
(63) Continuation of application No. PCT/EP05/05863, filed on Jun. 1, 2005.

(30) Foreign Application Priority Data
Jun. 9, 2004 (DE) 102004028045.2

(51) Int. Cl. B01J 19/00; D21F 3/02; D21H 23/00

(52) U.S. Cl. 162/181.2; 162/206; 422/129

(57) ABSTRACT

SC paper which is produced from a fibrous stock suspension containing fibers which are partially loaded with ash is characterized in that the ash content in the SC fiber web which was produced from the fibrous stock suspension is higher than 35%, preferably higher than 39%. Newsprint which is produced from a fibrous stock suspension containing fibers which are partially loaded with ash is characterized in that the ash content in the newsprint fiber web which was produced from the fibrous stock suspension is higher than 15%, preferably higher than 19%. Wood-free, uncoated paper which is produced from a fibrous stock suspension containing fibers which are partially loaded with ash is characterized in that the ash content of the wood-free, uncoated fiber web which was produced from the fibrous stock suspension is higher than 15%, preferably higher than 19%.

### CROSS REFERENCE TO RELATED APPLICATIONS

This is a continuation of PCT application No. PCT/EP2005/005863, entitled “METHOD AND DEVICE FOR PREPARING A FIBROUS MATERIAL SUSPENSION”, filed Jun. 1, 2005.

### BACKGROUND OF THE INVENTION

1. Field of the Invention

The invention relates to SC paper which is produced from a fibrous stock suspension containing fibers which are partially loaded with ash. The invention also relates to news print and to wood-free uncoated (WFU) papers which are also produced from a fibrous stock suspension containing fibers which are partially loaded with ash.

2. Description of the Related Art

With papers which are produced in accordance with the current state of the art the observation is made that the ash retention in the wire section clearly decreases with increasing ash content. This creates an undesirable contamination of the water circuits inside the machine and the requirement for additional retention agent increases, thus affecting the formation of the paper. Also, the initial wet-strength diminishes with increasing ash content. This limits the rate with which the fiber web can be produced.

Another disadvantageous aspect is the dusting of the paper during offset or laser printing, especially with uncoated papers (SC-paper, newsprint, WFU paper). This causes contamination of the print units, thereby necessitating regular clean-up and down-times of the printing press or the copier.

Methods for the processing of a fibrous stock suspension according to the Fiber-Loading-Technology are already known from DE 101 13 998 A1 and DE 102 04 254 A1.

What is needed in the art is to increase the ash content in the above referenced paper types, however without the occurrence of the previously described negative paper characteristics.

### SUMMARY OF THE INVENTION

For SC paper of the type described at the beginning, the present invention provides that the ash content in the SC-paper fiber web which was produced from the fibrous stock suspension is higher than 35%, preferably higher than 39%.

For newsprint of the type described at the beginning, the present invention provides that the ash content of the news print fiber web which was produced from the fibrous stock suspension is higher than 15%, preferably higher than 19%.

For wood-free paper of the type described at the beginning, the present invention provides that the fiber web of the wood-free, uncoated paper which was produced from the fibrous stock suspension is higher than 15%, preferably higher than 19%.

The present invention permits maximization of the ash content in a paper, thereby providing economic and qualitative advantages. Ash is cheaper than fibrous stock and at the same time advantageous for the optical characteristics of whiteness and opacity.

It has been found that, given the same retention agent application the ash content is up to twenty percentage points higher than can be achieved under the current state of the art, due to the improved adhesion of the ash on the fibers. In addition, the initial wet strength is also increased by up to 20% with the same ash content. The dusting tendency of the paper is reduced by more than half. This permits the ash content in the paper to be clearly increased. Alternatively, an equivalent paper may be produced with a lower basis weight.

According to an embodiment of the present invention, relative to, but not limited to, the above referenced papers, a method includes the following process steps:
Adding calcium hydroxide in liquid or dry form, or of calcium oxide into the fibrous stock suspension;
Adding gaseous carbon dioxide into the fibrous stock suspension;
Precipitating calcium carbonate through the carbon dioxide;
Refining the fibrous stock suspension during the loading process; and
Washing the fibrous stock suspension prior to the crystallization process and/or the refining process and/or during the refining process and/or after the refining process.

According to another embodiment of the present invention, a method includes the following process steps:
Adding calcium hydroxide in liquid or dry form, or of calcium oxide into the fibrous stock suspension;
Adding gaseous carbon dioxide into the fibrous stock suspension;
Precipitating calcium carbonate through the carbon dioxide; and
Washing the fibrous stock suspension before delivering said fibrous stock suspension into a head box chest which is located downstream when viewed in the direction of the fibrous stock suspension flow and/or into a machine for further processing of the fibrous stock suspension. Depending on what is required of the end product, the Fiber-Loading-Technology will be applied either before or after the refining process.

The present invention provides a method for the production of fiber loaded precipitated calcium carbonate (FLPCC), especially for the production of chemical pulp or the use of chemical pulp in paper production. The fiber raw material which is to be loaded is produced for example from recycling paper, from DIP (de-inked paper), from secondary fiber stock, bleached or unbleached chemical pulp, wood pulp of all types, raw paper pulp of all types, bleached or unbleached sulfate pulp, broke, linen, cotton and/or hemp fibers (used predominantly for cigarette paper) and/or all other types of paper raw material which can be used in a paper machine.

The inventive method may be utilized independent of whether the end product contains a filler which was produced through a precipitation process in a batch reactor or through a refining process (GCC=ground calcium carbonate), or in which talcum, silicon, titanium dioxide (TiO2) are used.

In the FLPCC process described below, the filler material which is used in other manufacturing processes is being replaced with the filler material which is being produced by the fiber loading process technology. The scope of the filler produced according to the fiber loading process technology extends to the paper production and to the areas of application for all paper types, including wrapping papers, which possess a filler content of between 1 and 60%, or which have a white liner that has a filler content of between 1 and 60%.

The scope of the current invention is not limited to the use of these fillers in paper manufacturing processes; the invention may be utilized in any paper manufacturing process or related processes including the manufacture of chemical pulp. A completely new product including new and improved characteristic compared to products already on the market will result if a fibrous stock suspension is treated with the fiber loading technology during the paper manufacturing process. The process described below permits precipitation of a filler (calcium carbonate) which is evenly distributed and deposited only on and in the fibrous stock, especially the paper fiber to occur directly in the stock preparation section in a paper mill.

By way of a combination or by way of an individual application of the design forms of the current invention which are described below, only fibrous stock loaded with precipitated calcium carbonate is produced, whereby the calcium carbonate is attached on or in the fibers, or is embedded in them; this prevents the formation of loose precipitated calcium carbonate (PCC). An additional wash cycle before a refining process and/or after the refining process and/or before the crystallization process in a crystallizer and/or before the headbox chest or prior to delivery into the paper machine or recycling the press filtrate to a header tank or to another storage arrangement located on the infeed side provides that a constant calcium hydroxide content is adjusted or regulated in the infeed system of the fiber loading apparatus. The calcium hydroxide can be added directly in a fiber stock pulper. The press filtrate can be recycled into the pulper system. Calcium hydroxide which does not attach on or in the fibers is recycled back to the upstream processes.

Only that filler which is not attached on or in the fibers, in other words loose precipitated calcium carbonate, is washed out. The fibers themselves which are provided with filler on the inside and the outside do not lose said filler through the wash process and the recycling of the press filtrate, so that the positive effects of the fiber loading technology are maintained.

In addition to the design forms of the current invention which are described in more detail below, we also refer you to the design examples which are described in further detail in U.S. Pat. No. 6,413,365, DE 101 07 448 A1 and DE 101 13 998 A1 and with which the inventive method can also be implemented.

The present invention provides a method according to which the fibrous stock suspension is fed into a press arrangement intended to squeeze out a filtrate. Subsequently, the filtrate is recycled back, at least partially into an arrangement for pulping of the fibrous stock suspension, specifically into a reservoir which is located on the infeed side, for example a header tank. The calcium hydroxide is added at least partially in the arrangement for pulping of the fiber stock. In the complete pulper system, specifically in the arrangement for pulping of the fibrous stock, a pH value of between 7 and 12, especially between 9 and 12 is maintained.

In accordance with the current invention, aqueous fibrous stock material, especially aqueous paper stock having a consistency of 0.1 to 20%, preferably between 2 and 8%, can be used as primary raw material.

Calcium hydroxide in aqueous or in dry form, or calcium oxide are mixed into the aqueous paper fiber stock in a range of between 0.01 and 60% of the existing solids content. A static mixer, a header tank or a pulper system are utilized for the mixing process; a pH value in the range of between 7 and 12, preferably between 9 and 12, is applied. The reactivity of the calcium hydroxide is between 0.01 seconds and 10 minutes, preferably between 1 second and 3 minutes. Dilution water is added according to predetermined parameters.

Carbon dioxide is added into the moist paper stock suspension according to the reaction parameters. In doing so calcium carbonate precipitates in the carbon dioxide atmosphere.

At the same time a refining energy in the range between 0.1 and 300 kWh/ton dry paper pulp is applied. Compared to conventional processes for the production of a fibrous stock suspension, the current invention provides energy efficient attainment of a higher level of freeness; according to the current invention as much as 50% of refining energy can be saved. This affects especially all paper grades which undergo a refining process during their production cycle and particularly those that have a high or very high freeness value, for example FL-cigarette papers (FL=Fiber Loading), FL B&P papers, FL kraft sack papers and FL filter papers. With these papers which do not require fillers, loose filler which is not deposited on or in the fibers can be removed before the refining process or prior to feeding the fibrous stock suspension into the headbox chest or prior to entry into the paper machine. The fibers themselves however, are loaded inside and outside with filler, so that the positive effects of the fiber loading technology are maintained.

The high mechanical strengths in the end product which are achieved through the high freeness value positively affect the production of all paper grades since, due to process based mechanical loads in the various sections of the paper machine, such as in the press section, the dryer section or in the section where the web is wound, the produced intermediate product and the end product which is to be produced bear a high mechanical load due to utilization of winders, rewinders and converting machinery.

The inventive pre-treatment of the fibrous stock suspension also creates the basis for improved drying, thereby increasing the efficiency level in the production of all paper grades. Residual moisture contents in the range of 1 to 20% are advantageous.

With the current invention greater brightness and/or higher optical values of around 15 or more lightness points are also achieved on all grades of paper, cardboard or in various cardboard applications including the white liner on a cardboard layer.

The energy supply during the refining process, specifically the heat volume and the resulting warming effect are controlled. Crystals in various forms can be produced, according to the control.

In an additional embodiment, the current invention relates to a method which provides that a static mixer, a refiner, a disperger and/or a fluffer FLPCC reactor are utilized as a reactor, whereby the fibrous stock content, especially the paper content is between 0.01 and 15% in the instance of a static mixer, at between 2 and 40% in the instance of a refiner and a disperger, especially between 2 and 8% for LC refining and between 20 and 35% for HC-refining and between 15 and 60% in the instance of a fluffer-FLPCC-reactor.

The current invention also relates to a method according to which an expenditure of energy of between 0.3 and 8 kWh/t, especially between 0.5 and 4 kWh/t, is used for the precipitation reaction, especially if no refining process is utilized.

The process temperature is preferably between −15° C. and 120° C., especially between 20 and 90° C. Rhombohedral, scalenohedron and spherical crystals are formed, whereby the crystals measure between 0.05 and 5 μm, especially between 0.3 and 2.5 μm.

Static and/or moving, especially rotating mixing elements are utilized for the production of a fibrous stock suspension which is loaded with calcium carbonate.

The process is preferably conducted in a pressure range of between 0 and 15 bar, especially between 0 and 6 bar. Also, the process is carried out at a pH value that is preferably between 6 and 10, especially between 6.5 and 9.0. The reaction time is between 0.01 seconds and 1 minute, especially between 0.05 seconds and 10 seconds.

An additional advantage when utilizing the inventive technology with the above referenced paper grades is that these can also be further processed in a calender. Blackening is avoided due to the fact that when using the fiber loading technology, fiber loading particles are deposited in, around and on the fibers.

Compared to a fibrous stock which is produced according to conventional methods, a fibrous stock produced in accordance with the fiber loading combination process technology possesses a superior dewatering capacity which is in the range of between 5 to 100 ml CSF or 0.2 to 15° SR, depending upon the required level of freeness and filler content. This fibrous stock possesses a lower water retention capacity of approximately 2 to 25%, depending upon the raw material that is used in the paper manufacturing process. Compared to conventional fibrous stock the water can be removed more quickly from the fibrous stock suspension, and the fibrous stock dries accordingly faster. This also has a positive effect on remoistening which, as a result, is diminished in the paper manufacturing process, and upon the printability of the produced paper grades.

The current invention also relates to an apparatus for the implementation of one of the methods described above.

According to the current invention the apparatus is characterized in that it includes a static mixer, a processing unit for the addition of calcium oxide or calcium hydroxide, a press or dewatering screw, an equalizing reactor or an equalizing screw, a container serving as crystallizer, an additional static mixer, a carbon dioxide storage tank or an additional device for the recovery of carbon dioxide.

One advantageous embodiment provides for a high consistency refiner and/or a carbon dioxide heater and/or a storage tank for press water or for water which was removed in the dewatering screw.

It is also advantageous if fiber stock suspension filtrate which is recovered in the dewatering screw is returned via a line to a header tank or to another upstream device for the preparation of the fibrous stock suspension.

An additional washer unit for cleansing of the fibrous stock suspension after the crystallizer is also advantageous.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic illustrating the preparation of a fibrous stock suspension for application in a machine for the production of a fiber web; and

FIGS. 2-4 are schematics illustrating embodiments of paper machines for the production of SC paper, news print or wood-free uncoated paper.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

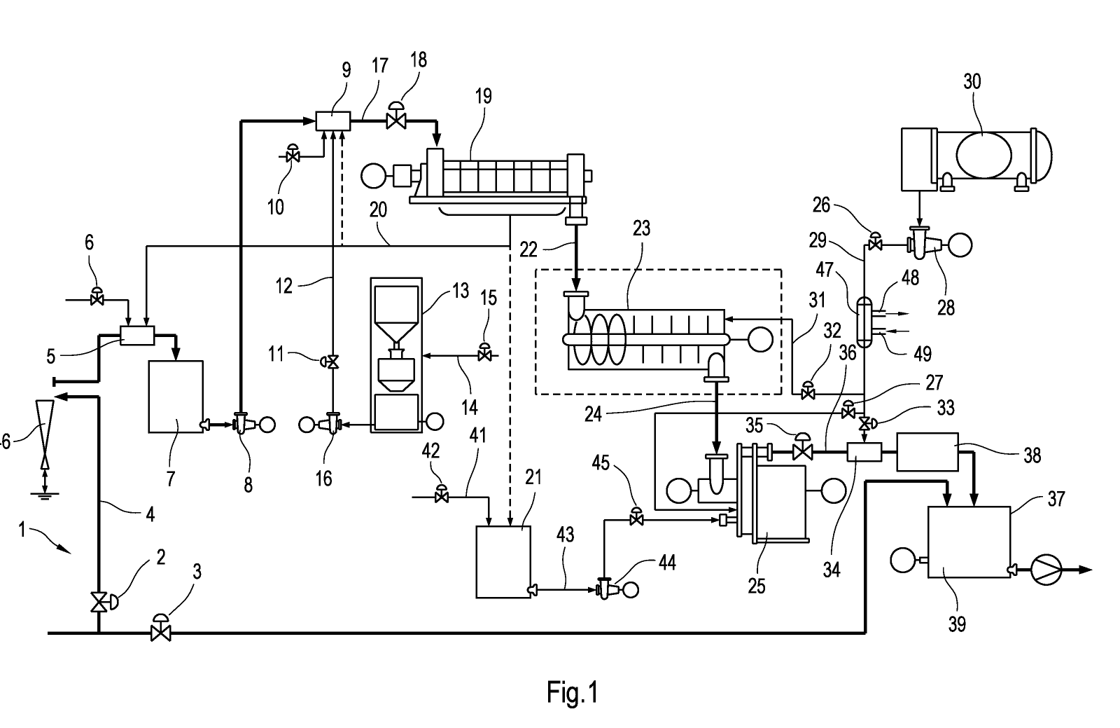

Referring now to the drawings, and more particularly to FIG. 1, there is shown a pipe line system 1 that is equipped with control valves 2, 3 and that is provided for a fibrous stock suspension. The control valve 2 is located in a line 4 through which the pipe line system 1 is connected with a static mixer 5. Dilution water is added to the mixer 5 via a valve 6. A tank 7 or a container for storage of the fibrous stock suspension is located following the mixer 5, viewed in direction of the fiber stock flow direction. From the tank 7 the fibrous stock suspension is pumped via a pump 8 to an additional static mixer 9. Dilution water is also added to the mixer 9 via a valve 10. Likewise, the inflow of a calcium hydroxide suspension is controlled through a valve 11 which is located in a line 12.

This is supplied by a processing unit 13 where solid calcium oxide or calcium hydroxide is added to water. For this purpose the processing unit 13 is supplied with water via a line 14 which is equipped with a valve 15. The suspension that is produced in the processing unit 13 is supplied through a pump 16 into the line 12.

The fibrous stock suspension to which calcium hydroxide was added flows from the mixer 9 into a line 17 which is equipped with a valve 18 to a dewatering screw 19 where water is removed from the fibrous stock suspension. Said water can, for example be returned through a line 20 to the mixer 5 as dilution water. Alternatively, or in addition, the water that was removed in the dewatering screw 19 may also be routed to a storage tank 21 for the fibrous stock suspension, or it is returned to the mixer 9. Due to the return flow of calcium hydroxide containing water the pH value can be increased and adjusted in all instances in the units that are located preceding the dewatering screw 19.

In order to equalize the fibrous stock suspension, said suspension is delivered via a line 22 from the dewatering screw 19 to an equalizing screw 23. A downstream container 25 (crystallizer) is connected through a line 24 with said equalizing screw. For the purpose of supplying carbon dioxide this container is connected with a carbon dioxide storage container 30 via a line 29 which is equipped with valves 26, 27 and a pump 28.

Carbon dioxide is supplied from this container into the crystallizer 25 in order to produce the desired precipitation reaction of calcium hydroxide and carbon dioxide for the formation of calcium carbonate as a filler in the fibers of the fiber stock.

In addition the carbon dioxide storage container 30 is connected with the equalizing screw 23 via an additional line 31 which is equipped with a valve 32 and which branches off line 29. Carbon dioxide can herewith also be supplied to the equalizing screw in order to achieve at least a partial precipitation already at this point.

Line 29 is also connected via an additional valve 33 with a static mixer 34. This serves to add additional carbon dioxide to the fibrous stock suspension which is flowing from the crystallizer 25 via a line 36 which is equipped with a valve 35.

The fibrous stock suspension flows from the mixer 34 into a mixing chest 37. A storage tank 38 which additionally serves as a filtration unit may be provided between the mixer 34 and the mixing chest 37. From the storage tank 38 the filtrate which has been enriched with calcium carbonate is recycled back into the header tank 7 or into another upstream unit for the processing of the dilution water or the fibrous stock suspension. The mixing chest 37 is equipped with a rotor 39 to thoroughly mix the fibrous stock suspension. The fibrous stock suspension then flows from the mixing chest 37 either immediately to a head box in a paper machine, or will be subjected to additional mechanical processing, for example in a refiner feed chest.

Fibrous stock suspension to which calcium hydroxide has not yet been added can also be supplied to the mixing chest 37 through a pipe line system 1 via the valve 3 and a line 40 in which said valve is installed.

It is further provided that white water or process water which has been recovered from the machine for the production of the fibrous stock suspension, especially from the paper machine, for example in the wire area of the paper machine or, as already described previously, for the fibrous stock suspension from the dewatering screw 19, is supplied to the tank 21. Dilution water may for example be supplied to this tank through a line 41 which is equipped with a valve 42.

From the container 21 dilution water which is mixed with process water flows through a line 43, a pump 44 and a valve 45 to the crystallizer 25. According to the design of an arrangement for loading of the fibrous stock suspension with a filler, especially with calcium carbonate as depicted in FIG. 1, a multitude of possibilities arise to influence the composition of the fibrous stock suspension that is being produced in various stages of the manufacturing process.

The installation of a high consistency refiner 46 inside line 4 is advantageous. A heater 47 for the carbon dioxide which is supplied by the storage tank 30 is optional. The heater 47 operates with superheated steam which is supplied via an inlet 49 and discharged via an outlet 48.

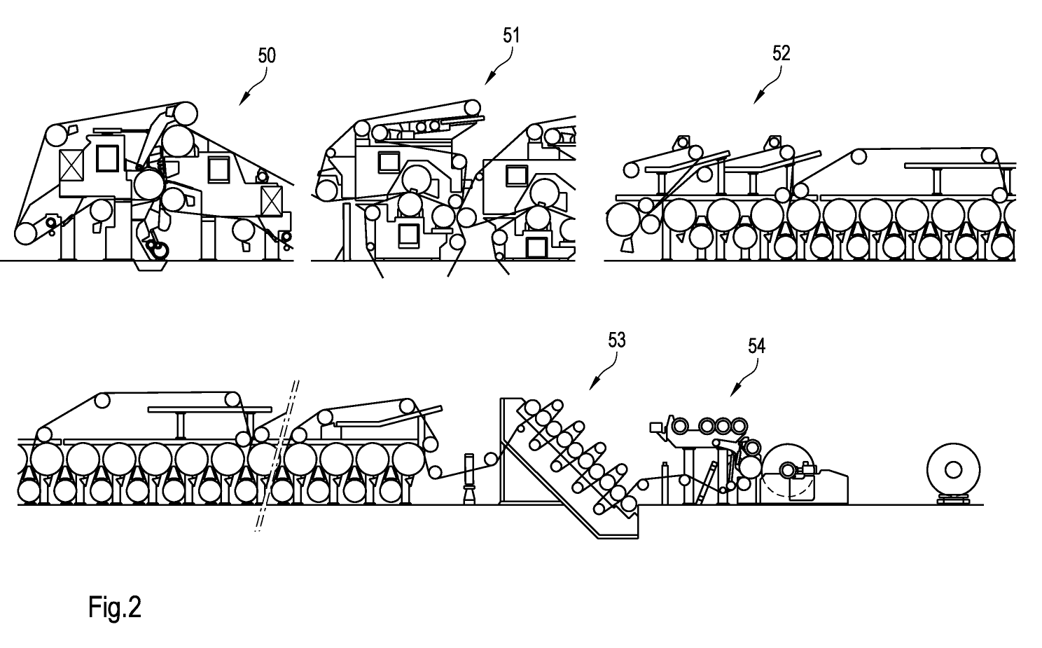

A machine as illustrated in FIG. 2 is suitable for the production of a SC paper web (SC=super-calendered) or magazine type paper. The machine includes a twin wire former 50, a press section 51 with two press nips arranged in tandem, a single row dryer section 52, calender 53 with a multitude of soft and hard rolls, as well as a winder 54.

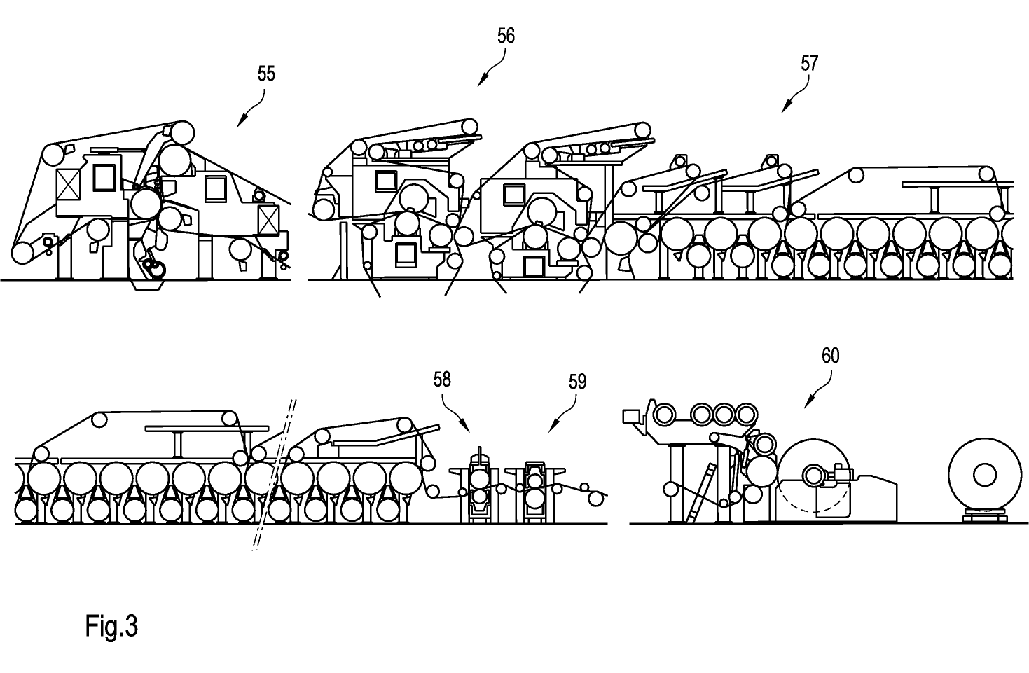

A machine (FIG. 3) is provided for the production of newsprint, including a twin wire former 55, a press section 56 and two press nips arranged in tandem, a single row dryer section 57 and two calendars 58, 59 whereby each is equipped with one soft and one hard roll. The paper web is wound on a winder 60.

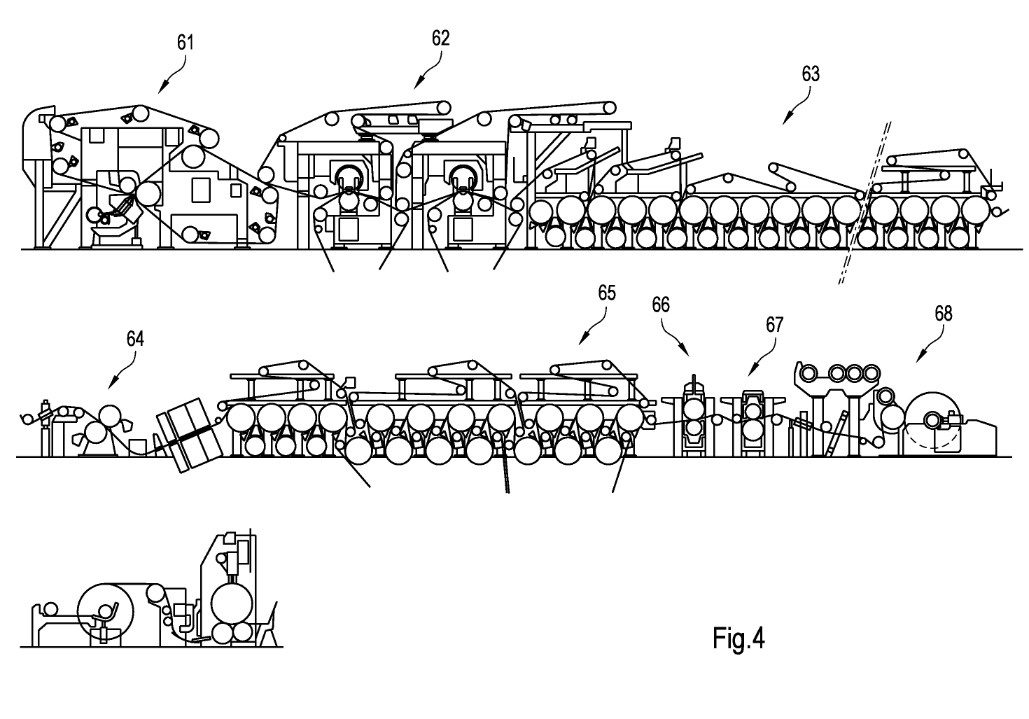

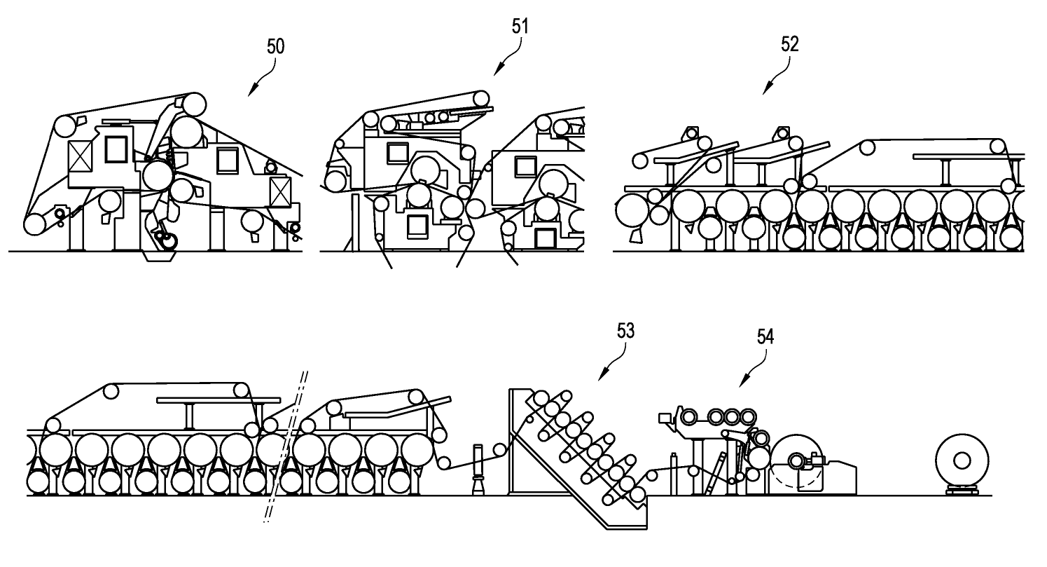

A machine (FIG. 4) for the production of WFU-paper includes a twin wire former 61, a press section 62 with two press nips arranged in tandem, a single row dryer section 63 within which a coating unit 64 is located, a two-row dryer section 65, two calenders 66, 67 each of which is equipped with one pair of rolls, and a winder 68.

### Component Identification Listing

1 Pipe line system
2 Control valve
3 Control valve
4 Line
5 Static mixer
6 Valve
7 Header tank
8 Pump
9 Static mixer
10 Valve
11 Valve
12 Line
13 Processing unit
14 Line
15 Valve
16 Pump
17 Line
18 Valve
19 Dewatering screw
20 Line
21 Storage tank
22 Line
23 Equalizing screw
24 Line
25 Container
26 Valve
27 Valve
28 Pump
29 Line
30 Carbon dioxide storage tank
31 Line
32 Valve
33 Valve
34 Static Mixer
35 Valve
36 Line
37 Mixing chest
38 Storage tank
39 Rotor
40 Line
41 Line
42 Valve
43 Line
44 Pump
45 Valve
46 High consistency refiner
47 Heater
48 Inlet
49 Outlet
50 Twin wire former
51 Press section
52 Dryer section
53 Calender
54 Winder
55 Twin wire former
56 Press section
57 Dryer section
58 Calender
59 Calender
60 Winder
61 Twin wire former
62 Press section
63 Single row dryer section
64 Coating unit
65 Two-row dryer section
66 Calender
67 Calender
68 Winder

What is claimed is:

1. A super-calendered paper which is produced from a fibrous stock suspension having fibers which are partially loaded with ash, said super-calendered paper comprising a super-calendered fiber web produced from the fibrous stock suspension, said super-calendered fiber web having an ash content higher than 35%.

2. The super-calendered paper of claim 1, wherein said ash content is higher than 39%.

3. A newsprint paper which is produced from a fibrous stock suspension having fibers which are partially loaded with ash, said newsprint paper comprising a newsprint fiber web produced from the fibrous stock suspension, said newsprint fiber web having an ash content higher than 15%.

4. The newsprint paper of claim 3, wherein said ash content is higher than 19%.

5. A wood-free uncoated paper which is produced from a fibrous stock suspension having fibers which are partially loaded with ash, said wood-free uncoated paper comprising a wood-free uncoated fiber web produced from the fibrous stock suspension, said wood-free unocoated fiber web having an ash content higher than 15%.

6. The wood-free uncoated paper of claim 5, wherein said ash content is higher than 19%.

7. A method for the production of a super-calendered paper fiber web, at least partially loaded with ash, utilizing a fibrous stock suspension having a plurality of cellulose fibers which are loaded with calcium carbonate, said method comprising the steps of:
adding one of calcium hydroxide in one of liquid and dry form into the fibrous stock suspension and calcium oxide into the fibrous stock suspension;
adding gaseous carbon dioxide into the fibrous stock suspension;
precipitating the calcium carbonate through said carbon dioxide;
refining the fibrous stock suspension during a loading process; and
washing the fibrous stock suspension at least one of prior to a crystallizing process, prior to a refining process, during said refining process, and after said refining process.

8. A method for the production of a super-calendered paper fiber web, at least partially loaded with ash, utilizing a fibrous stock suspension having a plurality of cellulose fibers which are loaded with calcium carbonate, said method comprising the steps of:
adding one of calcium hydroxide in one of liquid and dry form into the fibrous stock suspension and calcium oxide into the fibrous stock suspension;
adding gaseous carbon dioxide into the fibrous stock suspension;
precipitating the calcium carbonate through said carbon dioxide; and
washing the fibrous stock suspension prior to feeding the fibrous stock suspension at least one of into a headbox chest that is located downstream in a flow direction of the fibrous stock suspension and into a machine for further processing of the fibrous stock suspension.

9. The method of claim 8, wherein an expenditure of energy of between 0.3 and 8 kWh/t is used for a precipitation reaction when no refining process is utilized.

10. The method of claim 8, wherein an expenditure of energy of between 0.5 and 4 kWh/t is used for a precipitation reaction when no refining process is utilized.

11. A method for the production of a super-calendered paper fiber web at least partially loaded with ash utilizing a fibrous stock suspension having a plurality of cellulose fibers which are loaded with calcium carbonate, said method comprising the steps of:
adding one of calcium hydroxide in one of liquid and dry form into the fibrous stock suspension and calcium oxide into the fibrous stock suspension;
adding gaseous carbon dioxide into the fibrous stock suspension;
precipitating the calcium carbonate through said carbon dioxide;
refining the fibrous stock suspension during a loading process;
washing the fibrous stock suspension at least one of prior to a crystallizing process, prior to a refining process, during said refining process, and after said refining process;
feeding the fibrous stock suspension into a press arrangement to squeeze out a filtrate from the fibrous stock suspension; and
at least partially returning said filtrate into an arrangement for pulping the fibrous stock suspension.

12. The method of claim 11, wherein said filtrate is returned into a supply-side reservoir.

13. The method of claim 11, wherein said filtrate is returned into a header tank.

14. The method of claim 11, wherein said calcium hydroxide is added at least partially in said arrangement for pulping the fibrous stock.

15. The method of claim 14, wherein at least in said arrangement for pulping the fibrous stock a pH value of between 7 and 12 is maintained.

16. The method of claim 14, wherein at least in said arrangement for pulping the fibrous stock a pH value of between 9 and 12 is maintained.

17. The method of claim 11, wherein an aqueous fibrous stock material having a consistency of 0.1 to 20% is used as a primary raw material.

18. The method of claim 11, wherein an aqueous fibrous stock material having a consistency of between 2 and 8% is used as a primary raw material.

19. The method of claim 11, wherein an aqueous paper stock having a consistency of 0.1 to 20% is used as a primary raw material.

20. The method of claim 11, wherein an aqueous paper stock having a consistency of between 2 and 8% is used as a primary raw material.

21. The method of claim 11, wherein said calcium hydroxide is mixed into an aqueous fiber stock material forming a solids content of between 0.01 and 60%.

22. The method of claim 11, wherein said calcium hydroxide is mixed into an aqueous paper fiber stock forming a solids content of between 0.01 and 60%.

23. The method of claim 11, wherein said calcium hydroxide is mixed in through one of a static mixer and a header tank.

24. The method of claim 11, wherein said calcium hydroxide reacts within a range of between 0.01 seconds and 10 minutes.

25. The method of claim 11, wherein said calcium hydroxide reacts within a range of between 1 second and 3 minutes.

26. The method of claim 11, wherein a dilution water is mixed into the fibrous stock suspension.

27. The method of claim 11, wherein a dilution water is mixed into the fibrous stock suspension one of prior to, during, and after adding at least one of said carbon dioxide and one of said calcium hydroxide and said calcium oxide.

28. The method of claim 11, wherein said carbon dioxide is mixed into the fibrous stock suspension, the fibrous stock suspension being moist.

29. The method of claim 11, a refining energy in a range between 0.1 and 300 kWh per ton of a dry paper pulp is applied.

30. The method of claim 29, wherein an energy supply is controlled by said refining process.

31. The method of claim 11, wherein at least one of a static mixer, a refiner, a disperger and a fluffer FLPCC reactor is utilized as a reactor, a fiber stock content being between 0.01 and 15% in an instance of said static mixer, said fiber stock content being between 2 and 40% in an instance of said refiner and in an instance of said disperger, and said fiber stock content being between 15 and 60% in an instance of said fluffer FLPCC reactor.

32. The method of claim 31, wherein said fiber stock content is between 2 and 8% for LC refining.

33. The method of claim 31, wherein said fiber stock content is between 20 and 35% for HC-refining.

34. The method of claim 11, wherein at least one of a static mixer, a refiner, a disperger and a fluffer FLPCC reactor is utilized as a reactor, a paper content being between 0.01 and 15% in an instance of said static mixer, said said paper content being between 2 and 40% in an instance of said refiner and in an instance of said disperger, and said paper content being between 15 and 60% in an instance of said fluffer FLPCC reactor.

35. The method of claim 34, wherein said paper content is between 2 and 8% for low consistency refining.

36. The method of claim 34, wherein said paper content is between 20 and 35% for high consistency refining.

37. The method of claim 11, wherein an expenditure of energy of between 0.3 and 8 kWh/t is used for a precipitation reaction.

38. The method of claim 11, wherein an expenditure of energy of between 0.5 and 4 kWh/t is used for a precipitation reaction.

39. The method of claim 11, wherein a process temperature is between −15° C. and 120° C.

40. The method of claim 11, wherein a process temperature is between 20 and 90° C.

41. The method of claim 11, wherein a plurality of rhombohedral, scalenohedron, and spherical crystals are formed.

42. The method if claim 41, wherein said plurality of crystals measure between 0.05 and 5 μm.

43. The method if claim 41, wherein said plurality of crystals measure between 0.3 and 2.5 μm.

44. The method of claim 11, wherein at least one of at least one static and at least one mixing element is utilized.

45. The method of claim 44, wherein at least one rotating mixing element is utilized.

46. The method of claim 11, wherein a pressure range of between 0 and 15 bar is utilized.

47. The method of claim 11, wherein a pressure range of between 0 and 6 bar is utilized.

48. The method of claim 11, wherein a pH value of between 6 and 10 is utilized.

49. The method of claim 11, wherein a pH value of between 6.5 and 9.0 is utilized.

50. The method of claim 11, wherein a reaction time is between 0.01 seconds and 1 minute.

51. The method of claim 11, wherein a reaction time is between 0.05 and 10 seconds.

52. An apparatus for producing a super-calendered paper fiber web, at least partially loaded with ash, utilizing a fibrous stock suspension having a plurality of cellulose fibers which are loaded with calcium carbonate, said apparatus comprising:
a plurality of static mixers;
a processing unit for adding one of calcium oxide and calcium hydroxide;
one of a press and a dewatering screw;
one of an equalizing reactor and an equalizing screw;
a container serving as a crystallizer; and
one of a carbon dioxide storage tank and a device for recovering carbon dioxide.

53. The apparatus of claim 52, further comprising at least one of a high consistency refiner, a carbon dioxide heater, and a storage tank one of for a press water and for a water recovered in said dewatering screw.

54. The apparatus of claim 52, further comprising a line and one of a header tank and an upstream device, said line and said one of said header and said upstream device configured for returning a filtrate recovered in said dewatering screw via said line one of to said header tank and to said upstream device for the purpose of processing the fibrous stock suspension.

55. The apparatus of claim 52, further comprising a washer apparatus for cleaning the fibrous stock suspension, said washer apparatus located after said container serving as said crystallizer.
